(19) United States
(12) Patent Application Publication
(10) Pub. No.: US 2009/0121149 A1
(43) Pub. Date: May 14, 2009

(54) TECHNIQUES FOR SHAPING AN ION BEAM

(75) Inventors: Svetlana Radovanov, Marblehead, MA (US); Frank Sinclair, Quincy, MA (US); Peter L. Kellerman, Essex, MA (US); Victor M. Benveniste, Gloucester, MA (US); Robert Lindberg, Rockport, MA (US)

Correspondence Address: HUNTON & WILLIAMS LLP/VARIAN SEMICONDUCTOR,;EQUIPMENT ASSOCIATES, INC., INTELLECTUAL PROPERTY DEPARTMENT, 1900 K STREET, N.W., SUITE 1200, WASHINGTON, DC, 20006-1109, US

(73) Assignee: Varian Semiconductor Equipment Associates, Inc., Gloucester, MA (US)

(21) Appl. No.: 11/937,849

(22) Filed: Nov. 9, 2007

(51) Int. Cl. H01J 3/18

(52) U.S. Cl. 250/396 R

(57) ABSTRACT

Techniques for shaping an ion beam are disclosed. In one particular exemplary embodiment, the techniques may be realized as an apparatus for shaping an ion beam. The apparatus may comprise an entrance electrode biased at a first voltage potential, wherein an ion beam enters the entrance electrode, an exit electrode biased at a second voltage potential, wherein the ion beam exits the exit electrode, and a first suppression electrode and a second suppression electrode positioned between the entrance electrode and the exit electrode, wherein the first suppression electrode and the second suppression electrode are independently biased to variably focus the ion beam.

### FIELD OF THE DISCLOSURE

The present disclosure relates generally to ion implantation and, more particularly, to techniques for shaping an ion beam.

### BACKGROUND OF THE DISCLOSURE

Ion implanters are widely used in semiconductor manufacturing to selectively alter conductivity of materials. In a typical ion implanter, ions generated from an ion source are directed through a series of beam-line components which include one or more analyzing magnets and a plurality of electrodes. The analyzing magnets select desired ion species, filter out contaminant species and ions having undesirable energies, and adjust ion beam quality at a target wafer. Suitably shaped electrodes may modify the energy and the shape of an ion beam.

FIG. 1 shows a conventional ion implanter 100 which comprises an ion source 102, extraction electrodes 104, a 90° magnet analyzer 106, a first deceleration (D1) stage 108, a 70° magnet analyzer 110, and a second deceleration (D2) stage 112. The D1 and D2 deceleration stages (also known as “deceleration lenses”) are each comprised of multiple electrodes with a defined aperture to allow an ion beam to pass therethrough. By applying different combinations of voltage potentials to the multiple electrodes, the D1 and D2 deceleration lenses can manipulate ion energies and cause the ion beam to hit a target wafer at a desired energy.

The above-mentioned D1 or D2 deceleration lenses are typically electrostatic triode (or tetrode) deceleration lenses. FIG. 2 shows a perspective view of a conventional electrostatic triode deceleration lens 200. The electrostatic triode deceleration lens 200 comprises three sets of electrodes: entrance electrodes 202 (also referred to as “terminal electrodes”), suppression electrodes 204 (or “focusing electrodes”), and exit electrodes 206 (also referred to as “ground electrodes” though not necessarily connected to earth ground). A conventional electrostatic tetrode deceleration lens is similar to the electrostatic triode deceleration lens 200, except that a tetrode lens has an additional set of suppression electrodes (or focusing electrodes) between the suppression electrodes 204 and the exit electrodes 206.

In the electrostatic triode deceleration lens 200, each set of electrodes may have a space to allow an ion beam 20 to pass therethrough (e.g., in the +z direction along the beam direction). As shown in FIG. 2, each set of electrodes may include two conductive pieces electrically coupled to each other to share a same voltage potential. Alternatively, each set of electrodes may be a one-piece structure with an aperture for the ion beam 20 to pass therethrough. As such, each set of electrodes are effectively a single electrode having a single voltage potential. For simplicity, each set of electrodes are referred to in singular. That is, the entrance electrodes 202 are referred to as an “entrance electrode 202,” the suppression electrodes 204 are referred to as a “suppression electrode 204,” and the exit electrodes 206 are referred to as an “exit electrode 206.”

In operation, the entrance electrode 202, the suppression electrode 204, and the exit electrode 206 are independently biased such that the energy and/or shape of the ion beam 20 is manipulated in the following fashion. The ion beam 20 may enter the electrostatic triode deceleration lens 200 through the entrance electrode 202 and may have an initial energy of, for example, 10-20 keV. Ions in the ion beam 20 may be accelerated between the entrance electrode 202 and the suppression electrode 204. Upon reaching the suppression electrode 204, the ion beam 20 may have an energy of, for example, approximately 30 keV or higher. Between the suppression electrode 204 and the exit electrode 206, the ions in the ion beam 20 may be decelerated, typically to an energy that is closer to the one used for ion implantation of a target wafer. Therefore, the ion beam 20 may have an energy of, for example, approximately 3-5 keV or lower when it exits the electrostatic triode deceleration lens 200.

The significant changes in ion energies that take place in the electrostatic triode deceleration lens 200 can have a substantial impact on a shape of the ion beam 20. FIG. 3 shows a top view of the electrostatic triode deceleration lens 200. As is well known, space charge effects are more significant in low-energy ion beams than in high-energy ion beams. Therefore, as the ion beam 20 is accelerated between the entrance electrode 202 and the suppression electrode 204, little change is observed in the shape of the ion beam 20. However, when the ion energy is drastically reduced between the suppression electrode 204 and the exit electrode 206, the ion beam 20 tends to expand in both X and Y dimensions at its edges. As a result, a considerable number of ions may be lost before they reach the target wafer, and the effective dose of the ion beam 20 is reduced.

There have been attempts to reduce the above-described space charge effect in an electrostatic triode lens. In one approach, for example, Pierce geometry, well known to those skilled in the art, is introduced to each electrode in the electrostatic triode deceleration lens. That is, each electrode is bent at its tip to a defined angle such that electric fields inside the electrostatic triode lens are such that they generate focusing forces counteracting the space charge spreading effects at the edge of an ion beam. However, this approach can only achieve a limited success in controlling ion beam shapes. Despite a changed shape, each electrode still remains one conductive piece biased with a single voltage potential. As a result, generation of the focusing forces at the edge of the ion beam is constrained by the overall voltage potential applied to the electrode. In addition, one particular shape of an electrode may be useful for adjustment of only one particular beam shape or the perveance of the ion beam.

In view of the foregoing, it may be understood that there are significant problems and shortcomings associated with current ion implantation technologies.

### SUMMARY OF THE DISCLOSURE

Techniques for shaping an ion beam are disclosed. In one particular exemplary embodiment, the techniques may be realized as an apparatus for shaping an ion beam. The apparatus may include an entrance electrode biased at a first voltage potential such that an ion beam enters the entrance electrode, an exit electrode biased at a second voltage potential such that the ion beam exits the exit electrode, and a first suppression electrode and a second suppression electrode positioned between the entrance electrode and the exit electrode, wherein a first gap is formed between the entrance electrode and the first suppression electrode, a second gap is formed between the first suppression electrode and the second suppression electrode, and a third gap is formed between the second suppression electrode and the exit electrode. The first suppression electrode and the second suppression electrode may be independently biased to variably focus the ion beam. Each of the first gap, the second gap, and the third gap may have a curvature, and at least two of the first gap, the second gap, and the third gap may have different curvatures.

In accordance with other aspects of this particular exemplary embodiment, the ion beam may be a ribbon beam.

In accordance with further aspects of this particular exemplary embodiment, at least one of the first suppression electrode and the second suppression electrode may be selectively biased to provide a focusing effect on the ion beam such that a horizontal (x-axis) shape of the ion beam is manipulated independent from a vertical (y-axis) shape of the ion beam.

In accordance with additional aspects of this particular exemplary embodiment, the first gap, the second gap, and the third gap may have different curvatures and at least one of the first gap, the second gap, and the third gap may have a gap spacing that varies along its curvature.

In accordance with other aspects of this particular exemplary embodiment, the first suppression electrode may include a first radius of curvature and the second suppression electrode may include a second radius of curvature.

In accordance with further aspects of this particular exemplary embodiment, at least one of the first suppression electrode and the second suppression electrode may be selectively biased to provide a focusing effect on the ion beam by adjusting at least one of the first radius of curvature and the second radius of curvature.

In accordance with additional aspects of this particular exemplary embodiment, the first radius of curvature and the second radius of curvature may be the same or different.

In accordance with other aspects of this particular exemplary embodiment, at least one of the first suppression electrode and the second suppression electrode may include a non-linear curvature.

In accordance with further aspects of this particular exemplary embodiment, the first suppression electrode and the second suppression electrode may be independently biased to further manipulate an energy of the ion beam.

In accordance with another exemplary embodiment, the techniques may be realized as a method for shaping an ion beam. The method may include providing an entrance electrode biased at a first voltage potential such that an ion beam enters the entrance electrode, providing an exit electrode biased at a second voltage potential such that the ion beam exits the exit electrode, and providing a first suppression electrode and a second suppression electrode positioned between the entrance electrode and the exit electrode, wherein the first suppression electrode and the second suppression electrode are independently biased to provide a controlled focusing effect on the ion beam such that focus in a long dimension of the ion beam is manipulated independent from focus in a short dimension of the ion beam.

In accordance with another exemplary embodiment, the techniques may be realized as a method for shaping a ribbon beam. The method may include providing two or more electrodes in an electrostatic lens configuration such that the two or more electrodes form a combination of curvatures and wherein a ribbon beam enters and exits the electrostatic lens configuration, and adjusting the combination of curvatures by selectively and independently biasing the two or more electrodes to provide a controlled focusing effect on the ion beam such that focus in a long dimension of the ion beam is manipulated independent from focus in a short dimension of the ion beam.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 depicts a conventional ion implanter.

FIG. 2 depicts a conventional electrostatic triode lens.

FIG. 3 depicts a conventional electrostatic triode lens.

FIG. 4 depicts a perspective view of an electrostatic lens configuration in accordance with an embodiment of the present disclosure.

FIGS. 5A-5C depict a top view of an electrostatic lens configuration in accordance with various embodiments of the present disclosure.

FIGS. 6A-6C depict a top view of an electrostatic lens configuration in accordance with various embodiments of the present disclosure.

### DETAILED DESCRIPTION OF EXEMPLARY EMBODIMENTS

Embodiments of the present disclosure illustrate an improved type of electrostatic lens having one or more variable-control suppression electrodes. These electrodes may include a variety of shapes and/or curvatures that are independently or separately biased with respect to one another thereby providing flexible and effective manipulation of an ion beam's shape as well as its energy.

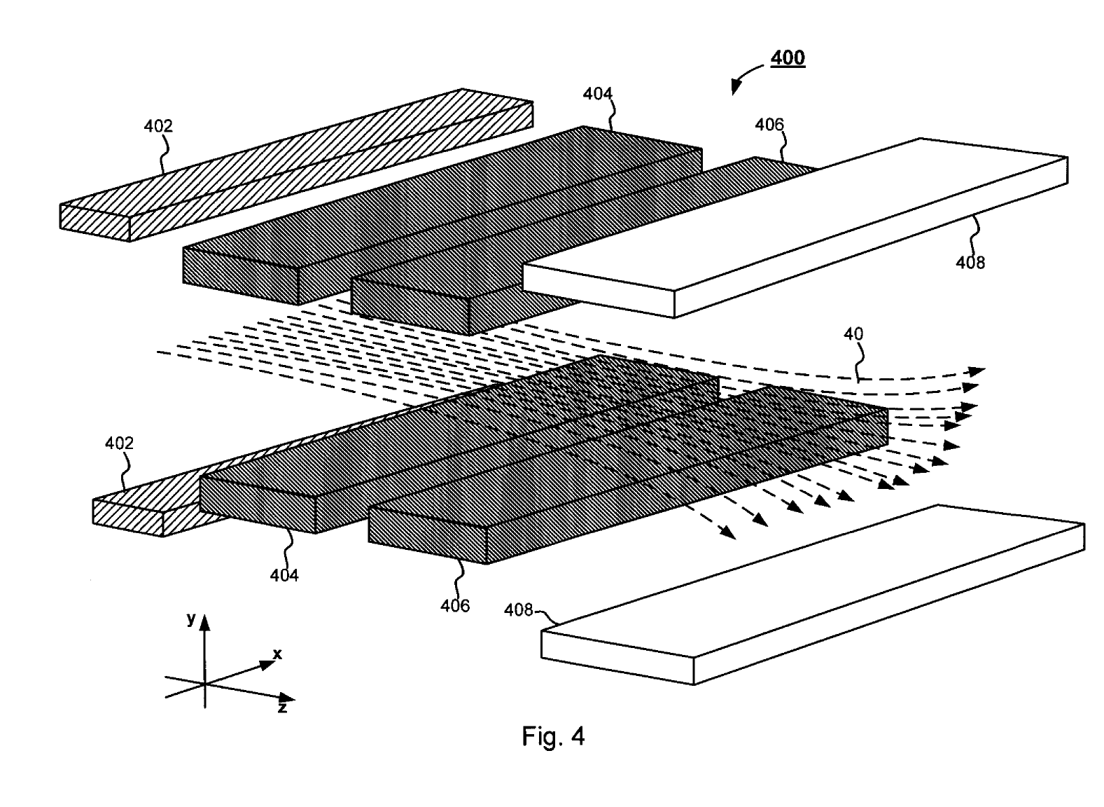

Referring to FIG. 4, there is shown a perspective view of an electrostatic lens configuration 400 in accordance with an embodiment of the present disclosure. Somewhat similar to a conventional electrostatic triode lens, the electrostatic lens configuration 400 may include an entrance electrode 402 and an exit electrode 408. Instead of a single suppression electrode, however, the electrostatic lens 400 may be a tetrode configuration including a plurality of electrodes (collectively referred to as “suppression electrode 404 and 406”) between the entrance electrode 402 and the exit electrode 408. In other words, rather than using a single suppression electrode, multiple electrodes (e.g. a first suppression electrode 404 and a second suppression electrode 406) may be independently positioned and biased to create desired electric fields in the electrostatic lens 400.

In one embodiment of the present disclosure, the first suppression electrode 404 and the second suppression electrode 406 may be coupled to one or more controller switches (not shown) for independently biasing voltages to each of the suppression electrodes 404 and 406. In this example, an ion beam 40 may enter the electrostatic lens 400 through an aperture at the entrance electrode 402. The ion beam 40 may be a ribbon-shaped ion beam that is wider in an x-direction than its height in a y-direction. Other various embodiments may also be provided.

In one embodiment, the ion beam 40 may have an initial energy of, for example, approximately 10-20 keV. Assuming the ion beam 40 mainly consists of positive ions, the entrance electrode 402 may be biased at a same or similar potential as the incoming ion beam 40. The first suppression electrode 404 and the second suppression electrode 406 may be independently biased (e.g., at a much lower potential than the entrance electrode 402). For example, according to one embodiment, the entrance electrode 402 may be biased at 22 keV and the first suppression electrode 404 may be biased at −11 keV. As a result, a strong electric field may be created to accelerate the positive ions as they travel from the entrance electrode 402 towards the suppression electrode 404. The second suppression electrode 406 may be inactive and the exit electrode 406 may be biased at a potential that is the same as or similar to a potential of a target wafer which receives the ion beam 40. In this embodiment, for example, the exit electrode 406 may be biased at ground potential, which decelerates the ions 40 to an energy of approximately 3-5 keV or lower.

In another embodiment, the entrance electrode 402 may be biased at −12 keV, the second suppression electrode 406 may be biased at −2 kev (the first suppression electrode 404 being inactive), and the exit electrode 406 may be biased at ground potential. As a result, an ion beam 40 with an initial energy of approximately 15 keV may be decelerated to approximately 3 keV upon exiting the deceleration lens 400.

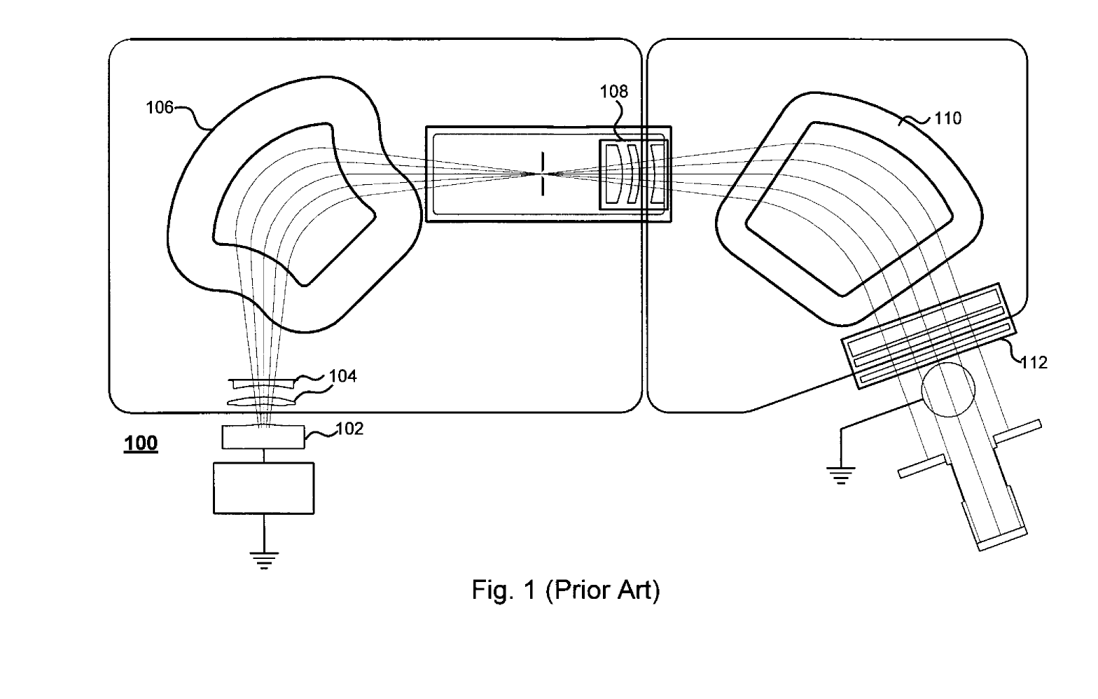

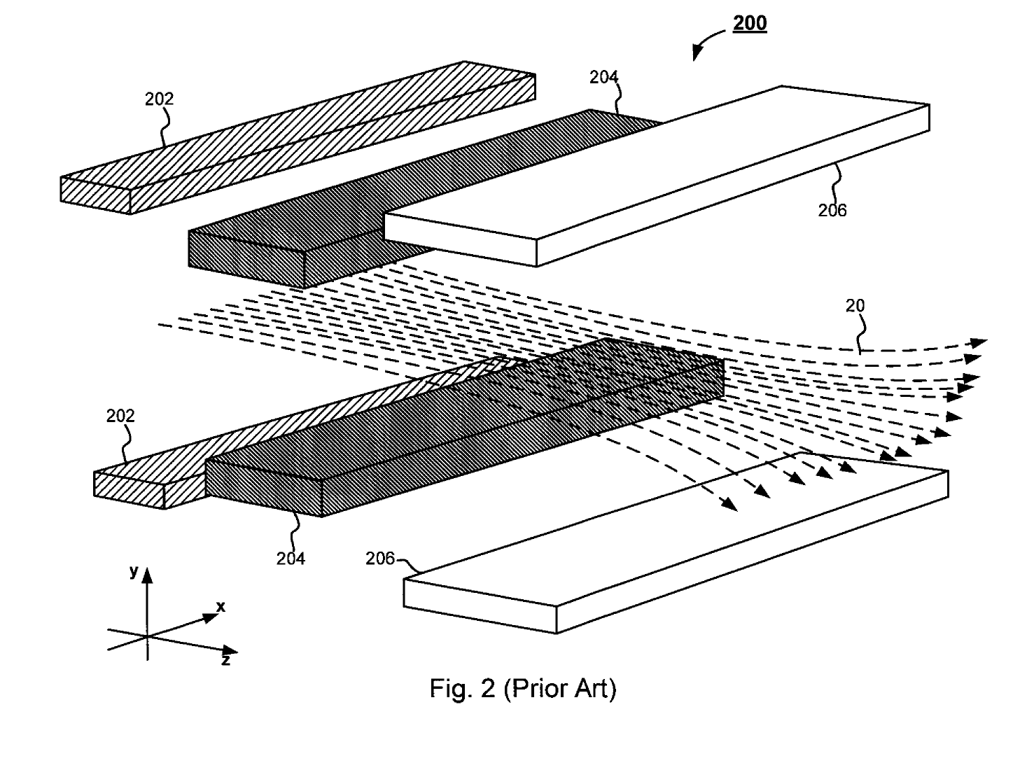

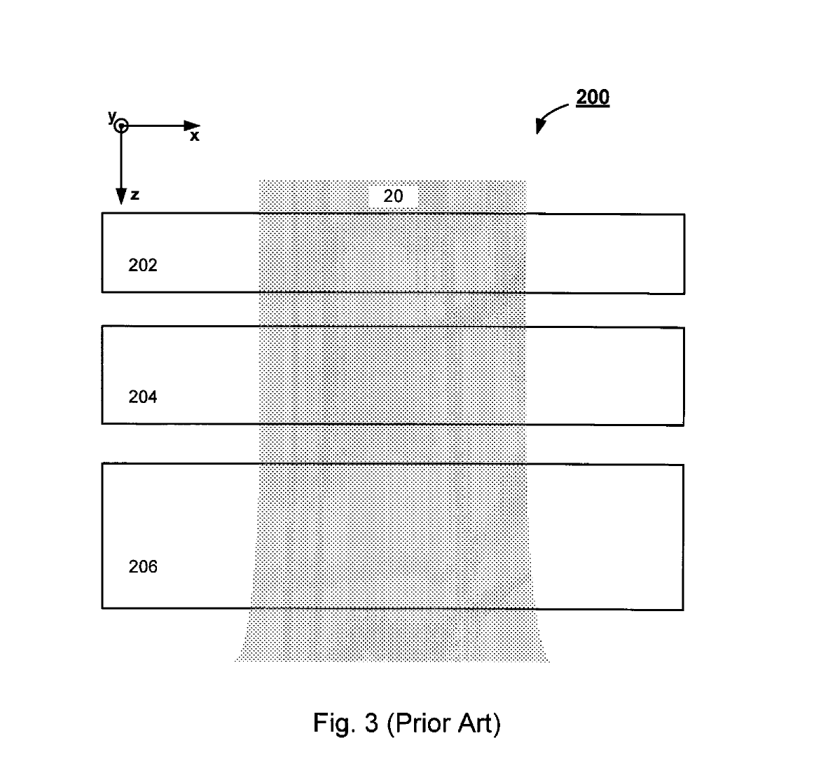

Depending on the specific usage in an ion implanter (e.g., either as D1 or as D2 deceleration lens shown in FIG. 1), the electrostatic lens 400 may be configured to, for example, adjust a divergence angle of the ion beam 40, or change a width of the ion beam 40, or do both. Since the main purpose of the electrostatic lens 400 is to reduce the divergence angle for the ion beam 40, the curvature of the suppression electrodes 404 and 406 may be essential in creating focusing forces along edges of the ion beam 40 to compensate for a defocusing effect of space charges. Accordingly, if the curvature(s) of each of the suppression electrodes 404 and 406 are properly determined, another technique may be provided to generate an ion beam 40 having a small divergence or none at all after being decelerated between the suppression electrodes 404 and 406 and the exit electrode 406. Thus, curvatures of the electrodes may further tailor electric fields (e.g., in the gaps between the electrodes) to produce focusing or defocusing forces as desired.

Depending on a shape of an incoming ion beam and a desired shape change, a first gap having a contour with defined curvature(s) may be provided between the entrance electrode 402 and the suppression electrode 404. Similarly, a second gap (between the first suppression electrode 404 and the second suppression electrode 406) and a third gap (between the second suppression electrode 406 and the exit electrode 408) may also be provided. In this example, each of these gaps may have a radius of curvature. For instance, the first gap may have may have a first radius of curvature, the second gap may have a second radius of curvature, and the third gap may have a third radius of curvature. In one embodiment, each of the radii of curvature may be different or not concentric. In another embodiment, the radius of curvature for the second gap may be the same as (or concentric to) the radius of curvature of the third gap. Other various combinations and/or embodiments may also be provided.

Although each of the gaps may provide acceleration or deceleration, the first gap generally involves acceleration and the second and third gaps generally involve deceleration. As a result, the second gap and the third gap may be referred to as “a first deceleration gap” and a “second deceleration gap,” respectively. According to another embodiment of the present disclosure, the first deceleration gap and the second deceleration gap may help provide optical properties for desired beam-shaping. For example, an over-curved electrode or lens (e.g., smaller radius of curvature) may more inwardly focus an ion beam at one of the gaps when compared to an under-curved electrode or lens (e.g., a larger radius of curvature), which may more outwardly focus an ion beam.

Embodiments of the present disclosure may provide variable focusing of suppression electrodes for a high perveance ribbon beam at low energy. Such a technique may also be used to controllably reduce ion beam energy and collimate a diverging ribbon ion beam. By independently and selectively adjusting each of the first suppression electrode 404 and the second suppression electrode 406 of the electrostatic lens configuration 400 (e.g., the first suppression electrode 404 and the second suppression electrode 406 having different but fixed shapes), variable focusing may be achieved, by at least one of acceleration or deceleration of the ion beam 40 at the first deceleration gap and/or the second deceleration gap. Not only does this technique provide desired correction to a shape of the ion beam 40, independently controlled electrodes ultimately provide a parallel ribbon ion beam 40 downstream from the electrostatic lens structure 400 for improved ion implantation.

It should be appreciated that, for illustration purposes, the upper and lower pieces in each electrode of the electrostatic lens 400 are treated as sharing a same shape and bias. However, this is only necessary when an ion beam is symmetric or non-diverging in the y-direction. It should be appreciated that the electrostatic lens techniques described herein may be applied in the y-direction as well as in the x-direction.

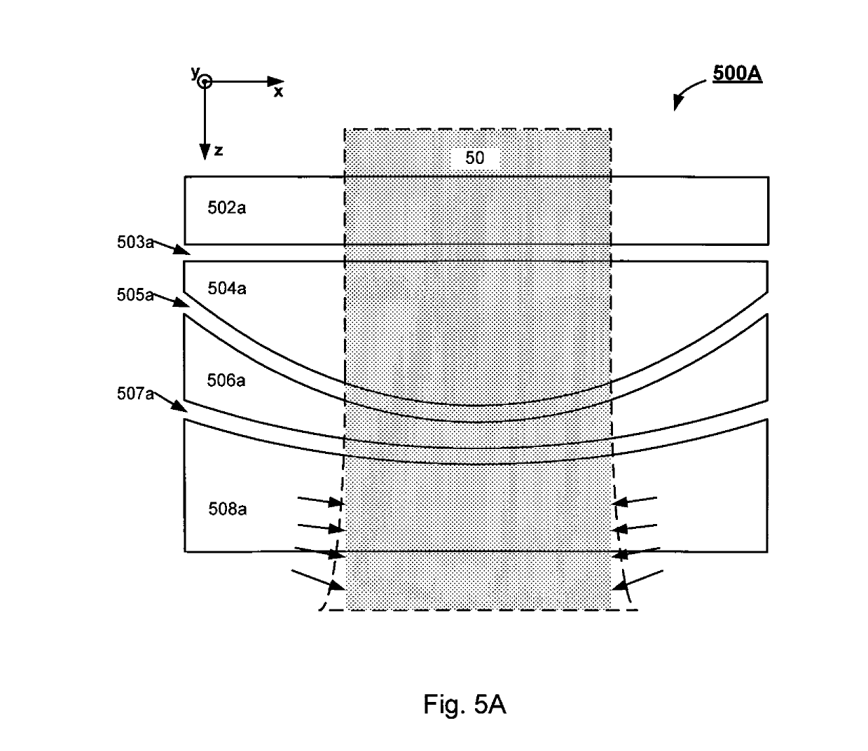

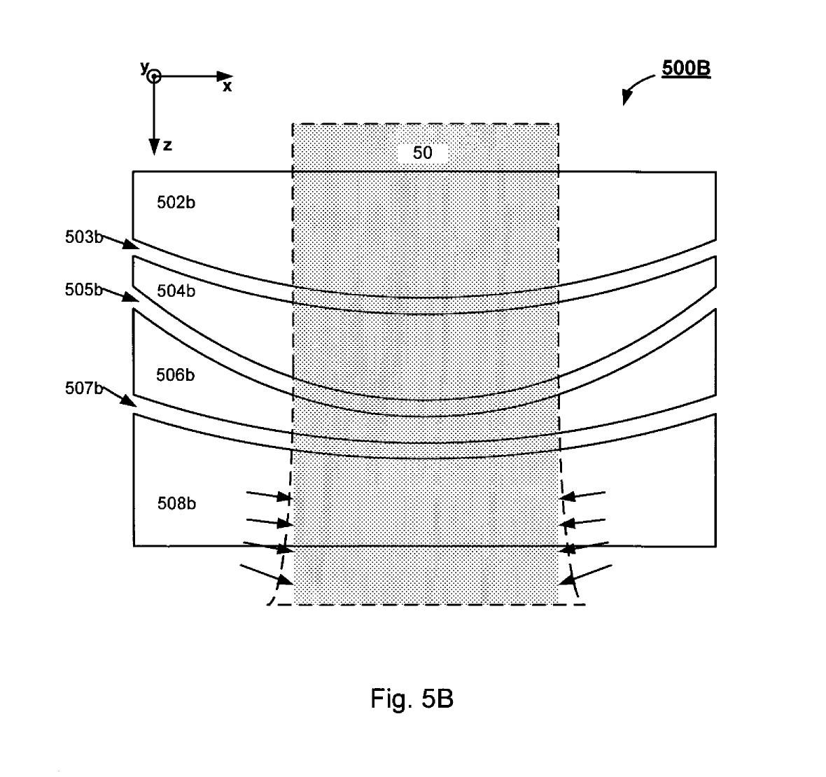

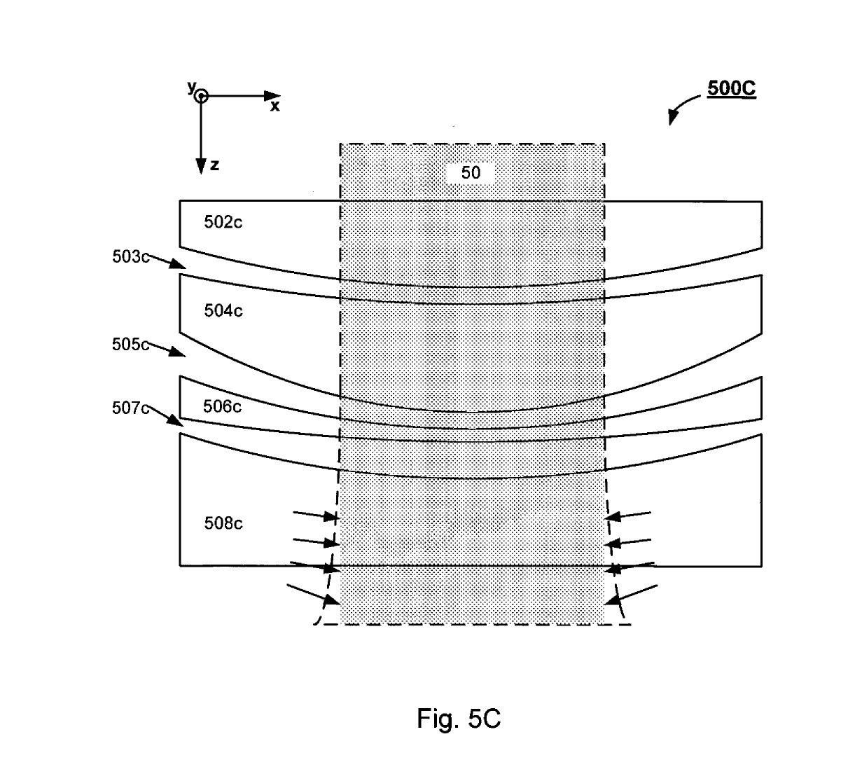

FIG. 5A depicts a top view of an electrostatic lens configuration 500A in accordance with an embodiment of the present disclosure. As discussed above, the defined curvatures) of the each of the gaps may be provided by curved electrodes. In this example, a first gap 503a may have a defined curvature that is flat (e.g., forming a right angle with the z direction) since an entrance electrode 502a may not have any curved sides or faces abutting a parallel face of a first suppression electrode 504a. A second gap 505a, however, may have a defined curvature since the first suppression electrode 504a may have convex shape where it abuts a face of the second suppression electrode 506a having a parallel side or face. The third gap 507a may also have a defined curvature since the second suppression electrode 506a may have a concave shape that abuts a parallel face of the exit electrode 508a. In this example, the second gap 505a may have a first radius of curvature and the third gap 507a may have a second radius of curvature. In this example, the second radius of curvature may be greater than that of the first radius of curvature.

FIG. 5B depicts a top view of an electrostatic lens configuration 500B in accordance with an embodiment of the present disclosure. Similar to FIG. 5A, the defined curvature(s) of the each of the gaps may be provided by curved electrodes. In this example, however, a first gap 503b may have a defined curvature that is not flat. A second gap 505a may have a defined curvature since the first suppression electrode 504a may have convex shape where it abuts a face of the second suppression electrode 506a having a parallel side or face. The third gap 507a may also have a defined curvature since the second suppression electrode 506a may have a concave shape that abuts a parallel face of the exit electrode 508a. In this example, the second gap 505a may have a first radius of curvature and the third gap 507a may have a second radius of curvature. In this example, the second radius of curvature may be greater than that of the first radius of curvature. As depicted in FIG. 5B, the first gap 503b, the second gap 505b, and the third gap 507b may have different curvatures and shapes.

In another embodiment, as depicted in FIG. 5C, at least one of the first gap 503c, the second gap 505c, and the third gap 507c may have a gap spacing that varies along its respective curvature. For example, in this electrostatic lens configuration 500C, the entrance electrode 502c may have a curvature that does not fit parallel to that of the first suppression electrode 504c. As a result, the first gap 503a may have a wider spacing at either edge when compared to a middle portion of the first gap 503a. It should be appreciated that such gap variations may similarly apply to each of the gaps between the other electrodes (e.g., second suppression electrode 506c or exit electrode 508c). Also, it should be appreciated that the middle area may have a greater spacing than that of the edge areas, as depicted in the third gap 507c. Other various embodiments may also be provided.

It should be appreciated that when the defined curvatures of the second gap 505a and the third gap 507a are different or not concentric, or in this case, the second radius of curvature being greater than that of the first radius of curvature, further correction of undesirable divergence of the ion beam may be provided. Additionally, parallel trajectories for higher energy in the ion beam 50 may also be obtained to better shape a diverging ion beam 50 for improved control and uniformity across a wafer surface during ion implantation.

Focusing of the ion beam may be linear and may be expressed by:

1/f=(1/R₁)(1−n₁)+(1/R₂)(1−n₂),

n=[(E₀+E_{S})/E_{f}]^{1/2}

where f represents the focal point, R₁ represents a first radius of curvature, R₂ represents a second radius of curvature, n₁ represents are refraction index in a second gap, and n₂ represents a refraction index in a third gap.

By using a tetrode geometry, flexibility of the lens configuration may be provided. For example, using an electrostatic lens configuration 500 having a combination of curvatures may provide a substantial net x-axis divergence correction to achieve a substantially parallel beam. In addition to using a combination of curvatures, by switching and adjusting the voltage between the first suppression electrode 404 and the second suppression electrode 406, as discussed above with reference FIG. 4, curvatures of the electrostatic lens configuration 500 may further be changed and/or adjusted to provide a fine-tuned, net focusing effect for achieving desired ion beam 50.

In addition, since input ribbon beam emittance may vary for different ion species and a range of radii of curvatures of electrostatic plates may exist, necessary focusing of may be obtained even for high perveance ion beams (e.g. Boron), in which a very small curvature may be required for a very large deceleration ratio. Furthermore, such an electrostatic lens configuration 500 may collimate a ribbon ion beam 50 to form particle trajectories such that all ions exit the lens configuration 500 in an ion beam path that is parallel or convergent in a finite distance. This may optimize ion implanting conditions, especially for improved control and uniformity across a wafer surface. Ultimately, continuous variable intermediate voltage application at the suppression electrodes 504 and 506 may provide a combination lens configuration 500 having a “zoom” effect. This “zoom” effect not only improves beam performance but may also provide control of a horizontal (x-axis) shape independently from the vertical (y-axis) shape of the ion beam 50. Other various advantages and benefits may also be provided.

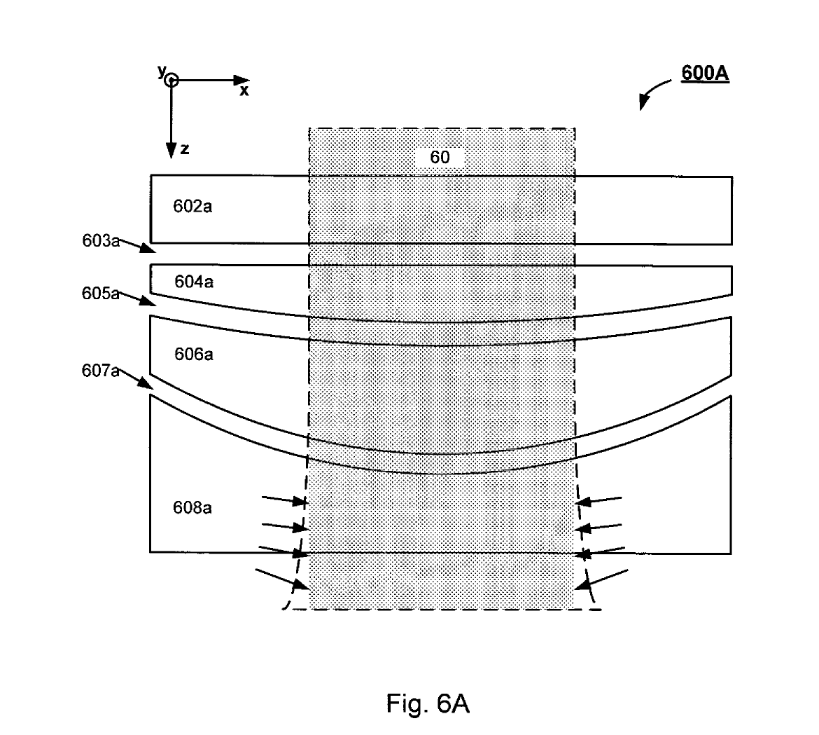

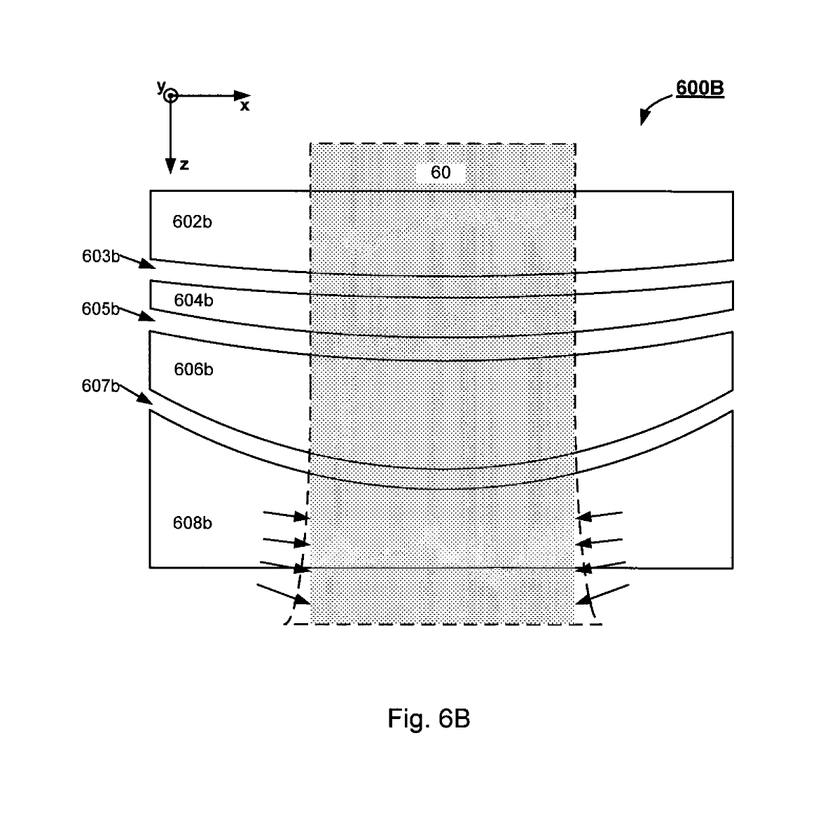

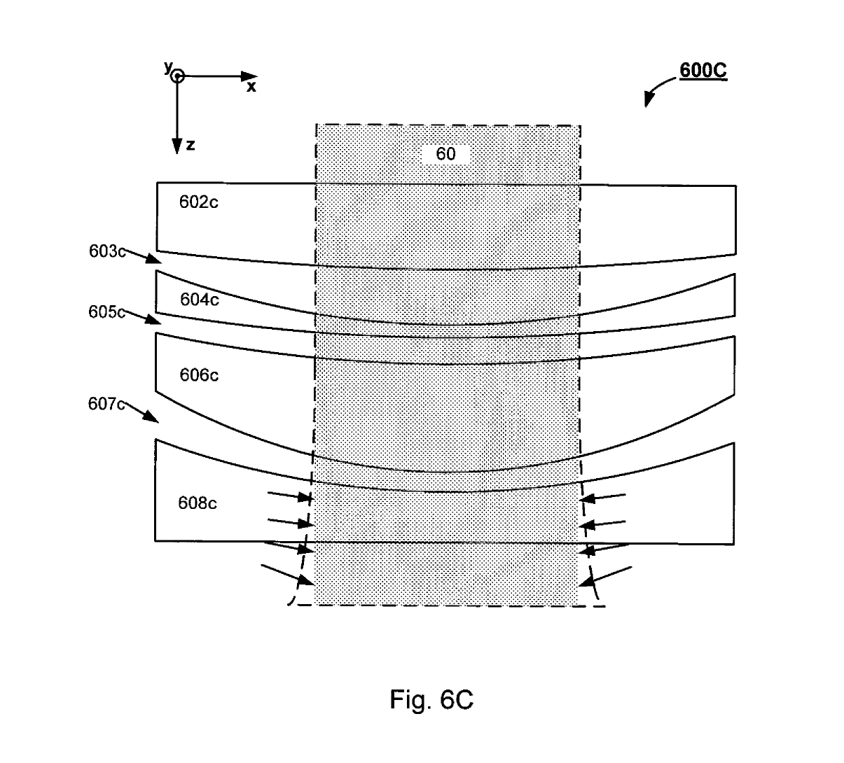

FIG. 6A depicts a top view of an electrostatic lens configuration 600A in accordance with an embodiment of the present disclosure. In this example the first suppression electrode 604a and the second suppression electrode 606a may both have convex shapes. Similar to FIG. 5A, gap 603a may have a defined curvature that is flat (e.g., forming a right angle with the z direction) since an entrance electrode 602a may not have any curved sides or faces abutting a parallel face of a first suppression electrode 604a. A second gap 605a, however, may have a defined curvature since the first suppression electrode 604a may have convex shape where it abuts a face of a second suppression electrode 606a having a parallel side or face. A third gap 607a may also have a defined curvature since the second suppression electrode 606a, also having a convex shape, may abut a parallel face of the exit electrode 608a. The second gap 605a may have a first radius of curvature and the third gap 607a may have a second radius of curvature. In this example, the second radius of curvature may be greater than that of the first radius of curvature. As discussed above, when the second radius of curvature is greater than that of the first radius of curvature, parallel trajectories for higher energy in the ion beam 40 may be obtained to better shape a diverging ion beam 60.

FIG. 6B depicts a top view of an electrostatic lens configuration 600B in accordance with an embodiment of the present disclosure. In this example the first suppression electrode 604b and the second suppression electrode 606 may both have convex shapes. Similar to FIG. 5B, gap 603b may have a defined curvature that is not flat. A second gap 605b, however, may have a defined curvature since the first suppression electrode 604b may have convex shape where it abuts a face of a second suppression electrode 606b having a parallel side or face. A third gap 607b may also have a defined curvature since the second suppression electrode 606b, also having a convex shape, may abut a parallel face of the exit electrode 608b. The second gap 605b may have a first radius of curvature and the third gap 607b may have a second radius of curvature. In this example, the second radius of curvature may be greater than that of the first radius of curvature. As discussed above, when the second radius of curvature is greater than that of the first radius of curvature, parallel trajectories for higher energy in the ion beam 40 may be obtained to better shape a diverging ion beam 60.

In another embodiment, as depicted in FIG. 6C, at least one of the first gap 603c, the second gap 605c, and the third gap 607c may have a gap that varies along the curve. For example, in this electrostatic lens configuration 600C, the entrance electrode 602c may have a curvature that does not fit parallel to that of the first suppression electrode 604c. As a result, the first gap 603a may have a wider spacing at a middle portion when compared to an edge portion of the first gap 603a. It should be appreciated that such gap variations may similarly apply to each of the gaps between the other electrodes (e.g., second suppression electrode 606c or exit electrode 608c). Also, it should be appreciated that the middle area may have a smaller spacing than that of the edge areas, as depicted in the third gap 607c. Other various embodiments may also be provided.

In both electrostatic lens configurations, as shown in FIGS. 5 and 6, actual voltage potentials applied to the independently biased electrodes may be either computationally determined based on mathematical models, or experimentally determined based on iterative adjustment of biasing voltages and measurement of angle response function(s). Alternatively, the computational and experimental methods may be combined in determining the biasing voltages.

It should be appreciated that electrode shapes (e.g., suppression electrode shapes) may be circular with a particular radius of curvature or may be more general. For example, in one embodiment, suppression electrodes may have shapes with non-linear curvatures. In this example, the non-linear curvature may be used to correct for second order effects caused by space charge forces or other similar forces. Furthermore, in another embodiment, when variable voltages are applied to these suppression electrodes such that a second suppression voltage may be held at a potential substantially identical to a potential at an exit electrode, the lens configuration may resemble, for example, an Einzel lens, which may provide optimized ion beam shaping. Other various embodiments may also be provided.

It should also be appreciated that operation of the electrostatic lens configurations in the embodiments described above may not be restricted to either acceleration or deceleration of an ion beam.

It should also be appreciated that while embodiments of the present disclosure are directed an electrostatic tetrode lens configuration, other various electrostatic lens configurations may also be provided. For example, variable control and curvature/shape requirements may also be provided in triode lens configurations or configurations having additional electrodes, e.g., configurations having multiple or segmented electrodes.

It should also be appreciated that while embodiments of the present disclosure are primarily directed to electrostatic lens configurations (e.g., deceleration lenses), magnetic lens configurations or other similar components, such as magnetic coils, correctors, or other magnetic tuning elements, may similarly utilize the techniques described above.

It should be also appreciated that while embodiments of the present disclosure are directed to utilizing a variable electrostatic lens in ion implantation, other implementations may be provided as well. For example, the disclosed techniques for utilizing a variable electrostatic lens may also apply to other various ion implantation systems that use electric and/or magnetic deflection or any other beam collimating systems.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for shaping an ion beam, the apparatus comprising:
an entrance electrode biased at a first voltage potential, wherein an ion beam enters the entrance electrode;
an exit electrode biased at a second voltage potential, wherein the ion beam exits the exit electrode; and
a first suppression electrode and a second suppression electrode positioned between the entrance electrode and the exit electrode, wherein a first gap is formed between the entrance electrode and the first suppression electrode, a second gap is formed between the first suppression electrode and the second suppression electrode, and a third gap is formed between the second suppression electrode and the exit electrode;
wherein the first suppression electrode and the second suppression electrode are independently biased to variably focus the ion beam;
wherein each of the first gap, the second gap, and the third gap has a curvature; and
wherein at least two of the first gap, the second gap, and the third gap have different curvatures.

2. The apparatus of claim 1, wherein the ion beam is a ribbon beam.

3. The apparatus of claim 1, wherein at least one of the first suppression electrode and the second suppression electrode is selectively biased to provide a focusing effect on the ion beam such that a horizontal (x-axis) shape of the ion beam is manipulated independent from a vertical (y-axis) shape of the ion beam.

4. The apparatus of claim 1, wherein the first gap, the second gap, and the third gap have different curvatures.

5. The apparatus of claim 1, wherein at least one of the first gap, the second gap, and the third gap has a gap spacing that varies along its curvature.

6. The apparatus of claim 1, wherein the first suppression electrode has a first radius of curvature and the second suppression electrode has a second radius of curvature.

7. The apparatus of claim 6, wherein at least one of the first suppression electrode and the second suppression electrode is selectively biased to provide a focusing effect on the ion beam by adjusting at least one of the first radius of curvature and the second radius of curvature.

8. The apparatus of claim 6, wherein the first radius of curvature and the second radius of curvature are the same.

9. The apparatus of claim 6, wherein the first radius of curvature and the second radius of curvature are the different.

10. The apparatus of claim 1, wherein at least one of the first suppression electrode and the second suppression electrode has a non-linear curvature.

11. The apparatus of claim 1, wherein the first suppression electrode and the second suppression electrode are independently biased to further manipulate an energy of the ion beam.

12. A method for shaping an ion beam, the method comprising:
providing an entrance electrode biased at a first voltage potential, wherein an ion beam enters the entrance electrode;
providing an exit electrode biased at a second voltage potential, wherein the ion beam exits the exit electrode; and
providing a first suppression electrode and a second suppression electrode positioned between the entrance electrode and the exit electrode, wherein the first suppression electrode and the second suppression electrode are independently biased to variably focus the ion beam such that focus in a long dimension of the ion beam is manipulated independent from focus in a short dimension of the ion beam.

13. The method of claim 12, wherein the ion beam is a ribbon beam.

14. The method of claim 13, wherein at least one of the first suppression electrode and the second suppression electrode is selectively biased to provide a focusing effect on the ion beam such that a horizontal (x-axis) shape of the ion beam is manipulated independent from a vertical (y-axis) shape of the ion beam.

15. The method of claim 12, further comprising:
providing a first gap between the entrance electrode and the first suppression electrode;
providing a second gap between the first suppression electrode and the second suppression electrode; and
providing a third gap between the second suppression electrode and the exit electrode; and
wherein each of the first gap, the second gap, and the third gap are areas for beam-shaping.

16. The method of claim 12, wherein the first suppression electrode has a first radius of curvature and the second suppression electrode has a second radius of curvature.

17. The method of claim 16, wherein at least one of the first suppression electrode and the second suppression electrode is selectively biased to provide a focusing effect on the ion beam by adjusting at least one of the first radius of curvature and the second radius of curvature.

18. The method of claim 16, wherein the first radius of curvature and the second radius of curvature are the same.

19. The method of claim 16, wherein the first radius of curvature and the second radius of curvature are the different.

20. The method of claim 11, wherein at least one of the first suppression electrode and the second suppression electrode has a non-linear curvature.

21. The method of claim 11, wherein the first suppression electrode and the second suppression electrode are independently biased to further manipulate an energy of the ion beam.

22. At least one processor readable medium for storing a computer program of instructions configured to be readable by at least one processor for instructing the at least one processor to execute a computer process for performing the method as recited in claim 12.

23. A method of shaping a ribbon beam, the method comprising:
providing two or more electrodes in an electrostatic lens configuration, wherein the two or more electrodes form a combination of curvatures and wherein a ribbon beam enters and exits the electrostatic lens configuration; and
adjusting the combination of curvatures by selectively and independently biasing the two or more electrodes to variably focus the ion beam such that focus in a long dimension of the ion beam is manipulated independent from focus in a short dimension of the ion beam.

24. At least one processor readable medium for storing a computer program of instructions configured to be readable by at least one processor for instructing the at least one processor to execute a computer process for performing the method as recited in claim 23.
